(19) United States
(12) Patent Application Publication
(10) Pub. No.: US 2007/0146446 A1
(43) Pub. Date: Jun. 28, 2007

(54) Ink jet cartridge comprising a porous core and methods for manufacturing the same

(76) Inventors: Jeffery James Buchanan, Lexington, KY (US); Stephen Francis DeFosse, Lexington, KY (US); James Harold Powers, Lexington, KY (US); David Amos Ward, Cynthiana, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/315,557

(22) Filed: Dec. 22, 2005

(51) Int. Cl. B41J 2/175

(52) U.S. Cl. 347/86

(57) ABSTRACT

A method of manufacturing an ink jet cartridge comprising, forming a porous core in the shape of a flow passage; placing the porous core in an ink jet cartridge mold; and injecting a molten material around the porous core. An ink jet cartridge for an ink jet printer having a porous core in the shape of a flow passage; an ink jet cartridge body formed by injecting a molten material around the porous core, wherein the ink jet cartridge body comprises a chamber configured to contain ink, and further wherein the porous core is in fluid communication with the ink in the chamber; and a printhead provided on the ink jet cartridge body and including ink ejection nozzles and ink ejectors, wherein the ink ejection nozzles are in fluid communication with the porous core.

### FIELD OF THE INVENTION

The present invention relates generally to ink jet cartridges, and more specifically to ink jet cartridge comprising a porous core and methods for manufacturing the same.

### BACKGROUND OF THE INVENTION

The ink jet printer generally includes a cartridge and a carrier. Typically, the ink jet cartridge body is comprised of a plastic material formed through injection molding. Additionally, the ink jet cartridge can also comprise an ink reservoir, such as a removable or separable tank, and a printhead. The ink jet printhead can comprise a printhead body, nozzles, and corresponding ink ejection actuators, such as heaters on a printhead chip. The actuators cause ink to be ejected from the nozzles onto a print medium at selected ink dot locations within an image area. The carrier moves the printhead relative to the medium, while the ink dots are jetted onto selected pixel locations, such as by heating the ink at the nozzles.

The ink jet cartridge can also include a filter within an ink passageway leading from the ink reservoir to the nozzles, for isolating any contaminants or debris from the ejectors and nozzles. The filter is typically swaged onto a tower or passage leading from the ink reservoir to the nozzles. The ink jet tank is configured to hold ink and includes an exit port configured to provide ink to a printhead.

However, typical ink jet cartridges which use filters suffer from a variety of design flaws. For example, the typical filter creates a large resistance to ink flow. As such, typical cartridge design strives to maintain as large a filter area as possible to reduce the flow resistance. Filters, however, typically are required to be flat and manufacturable. Thus, flexibility in cartridge design is severely restricted. As an additional example, the typical technique for filter attachment is heat stake, which requires the filter to be a distance away from the cartridge walls. Typical design guidelines today set that distance to be at least 1.5 mm. As a consequence, cartridge design is again limited.

In some other systems, it is also desirable to have multiple colors of ink jetted through a single printhead. As a consequence, the flow channels for one particular color must be isolated from the other colors by providing individual passageways through the cartridge and filter to the space around the printhead. However, forming these passageways within the cartridge body has become a very complicated problem.

For example, in ink jet cartridge molding, the passageways typically are not in the direction of pull of the plastic injection mold. As such, the cartridge body typically has to be made either with multiple pieces that must be attached to the cartridge, and/or with additional slides within the tool. However, both techniques can be quite costly and significantly limit the flexibility of cartridge designs.

Accordingly, there is a need for an ink jet cartridge which eliminates filter use to provide more flexibility in cartridge design and is also configured with a passageway for ink that is formed in a less complicated and less costly manner.

### SUMMARY OF THE INVENTION

Accordingly, some embodiments of the present invention are intended to address and obviate problems and shortcomings and otherwise improve previous ink jet cartridges. To achieve the foregoing and other objects in accordance with the exemplary embodiments of the present invention, one aspect of the present invention is a method of manufacturing an ink jet cartridge. The method comprises forming a porous core in the shape of a flow passage, placing the porous core in an ink jet cartridge mold and injecting a molten material around the porous core.

Another embodiment describes an ink jet cartridge for an ink jet printer. The ink jet cartridge comprises a porous core in the shape of a flow passage and an ink jet cartridge body formed by injecting a molten material around the porous core. The ink jet cartridge body comprises a chamber configured to contain ink and the porous core is in fluid communication with the ink in the chamber. The ink jet cartridge further comprises a printhead provided on the ink jet cartridge body and includes ink ejection nozzles and ink ejectors. The ink ejection nozzles are in fluid communication with the porous core.

Still other embodiments, combinations, advantages and objects of the present invention will become apparent to those skilled in the art from the following descriptions wherein there are shown and described alternative exemplary embodiments of this invention for illustrative purposes. As will be realized, the invention is capable of other different aspects, objects and embodiments all without departing from the scope of the invention. Accordingly, the drawings, objects, and description should be regarded as illustrative and exemplary in nature only and not as restrictive.

### BRIEF DESCRIPTION OF THE DRAWINGS

While the specification concludes with claims particularly pointing out and distinctly claiming the present invention, it is believed that the same will be better understood from the following description taken in conjunction with the accompanying drawings in which:

FIG. 1 is an exploded perspective view of an example embodiment of an ink jet cartridge, which is made and operates in accordance with principles of the present invention;

FIG. 2 is a cross-sectional view of an ink jet cartridge;

FIG. 3 is a perspective view of the bottom of an ink jet cartridge; and

FIG. 4 is a perspective cross-sectional view of another example embodiment of an ink jet cartridge, which is made and operates in accordance with principles of the present invention.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION OF THE EXEMPLARY EMBODIMENTS

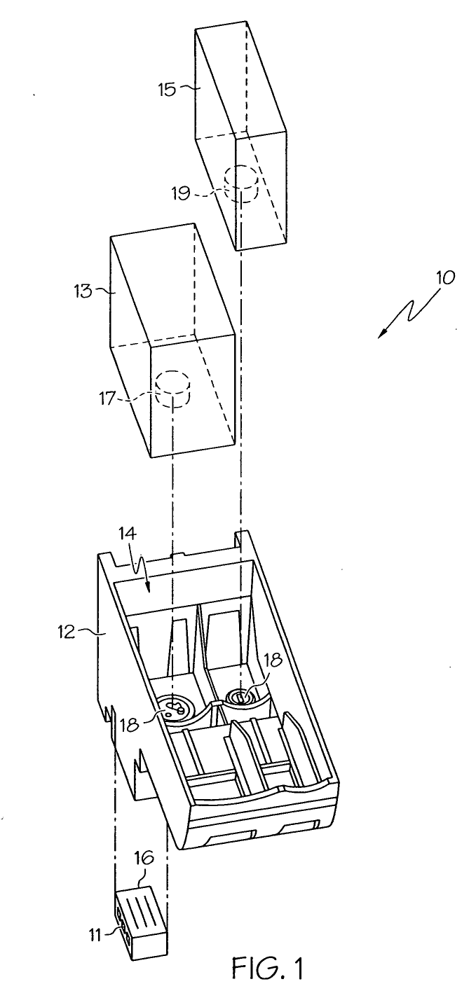

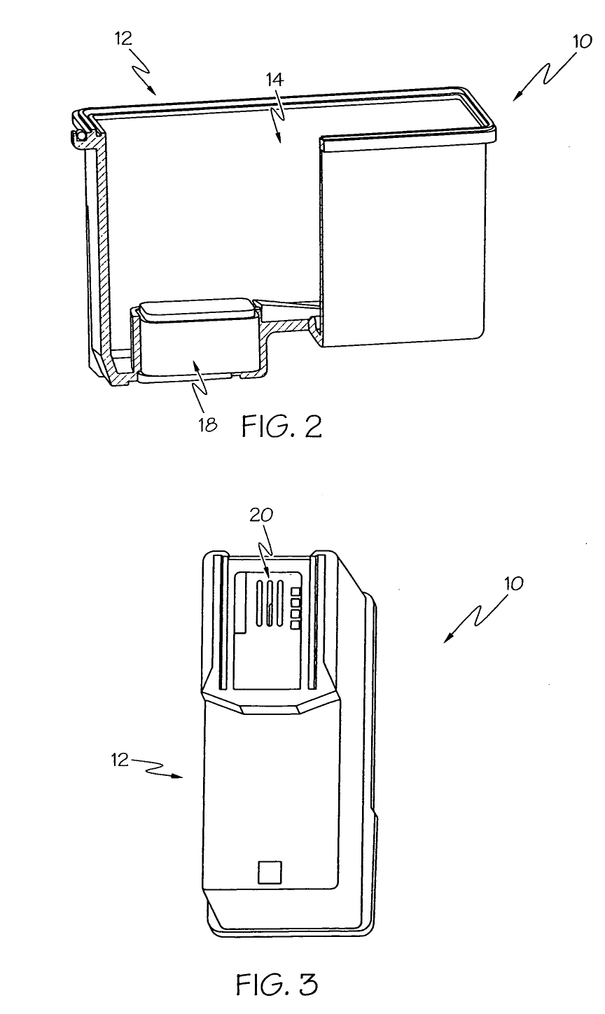

Referring to the drawing figures in detail, wherein like numerals indicate the same elements throughout the drawing figures, FIGS. 1-3 illustrate an embodiment of an ink jet cartridge comprising a porous core. Generally, the ink jet cartridge 10 includes an ink jet cartridge body 12 having an exit 20, a chamber 14 configured to contain ink and a porous core 18. In particular, in this example, the ink jet cartridge body 12 contains a chamber 14 that may be sized and configured to receive one or more ink tanks. For example, an ink tank 13 for black ink can be received in the chamber 14, and an ink tank 15 for one or more color inks can be received in the chamber as well. The ink tanks includes exit ports 17/19 for delivery of the ink, once installed in the chamber 14, and these ports can include an interface structure as appropriate, such as a lip or extension. The exit ports 17/19 can be sealed using a removable seal, which can be removed at the time of installation. Each tank 13/15 can include a backpressure device, such as a felt or foam structure for example, to retain the ink during storage. The tanks 13/15 and the chamber 14 can comprise any of a variety of shapes and sizes, and the inks within the tanks can comprise a variety of types of ink, as appropriate to the type of printer at hand.

Attached to the printhead cartridge body 12 is a printhead 16 including a plurality of nozzles 11 for delivery of the ink to the print medium. The ink flows from the exit ports 17/19 of the ink tanks 13/15 through a porous core 18 in the lower portion of the body 12. The ink can then flow from within the body 12 to a manifold in the printhead 16, from which it is drawn to nozzles for ejection onto the print medium, such as by using heater elements or piezoelectric elements for example. The ink jet cartridge 10 can be moved relative to the print medium, and the nozzles 11 can provide drops of ink at the desired location on the medium.

The porous core 18 is configured to be in fluid communication with the ink in the chamber 14. The porous core 18 serves as a flow passage for ink as it moves from the chamber 14 to the printhead 16. The porous core 18 isolates any contaminants or debris from the ink before it reaches the printhead 16 and, in particular, the ejectors and nozzles 11. Being porous, the core 18 is configured to allow liquids of low viscosity to flow through, such as water and ink. However, at the same time, the core 18 is configured to prevent solids and higher viscosity liquids from moving through. In one exemplary embodiment, the material of the porous core 18 is adapted to provide a porosity of at least about 63%-65% of an open volume and a pore size between 125 um-250 um. In another alternative embodiment, the porous core material can be selected from polypropylene, nylon, polyethylene, fluoropolymers, or other polymers, metals such as stainless steel or other metals or metal oxides (ceramics) such as aluminum oxide or other ceramics, porous copper and porous bronze or combinations thereof. An exemplary form of porous polyethylene or polypropylene is called POREX and is manufactured by Porex Technologies. An exemplary porous steel is called PORCERAX and is manufactured by International Mold Steels, Inc. Porous stainless steel (type 316L most commonly used) is manufactured in porosity ranges from near nano to 10's of microns by a significant number of companies world wide. Porous metal oxides or ceramics are also made in porosity ranges from near nano to 10's of micron ranges by a significant number of companies. In accordance with some embodiments, porous core materials are chosen to be compatible with the applicable fluid that is conveyed through the porous core, so as not to react chemically or physically with the fluid or any components contained in the fluid. This includes ionic transfer, creation of precipitants or other reactions.

The porous core 18 may be formed into a variety of shapes and sizes, as appropriate to the type of ink jet cartridge at hand. In one exemplary embodiment, the porous core 18 may be in the shape of a rectangle or alternatively, comprise the entire floor of chamber 14.

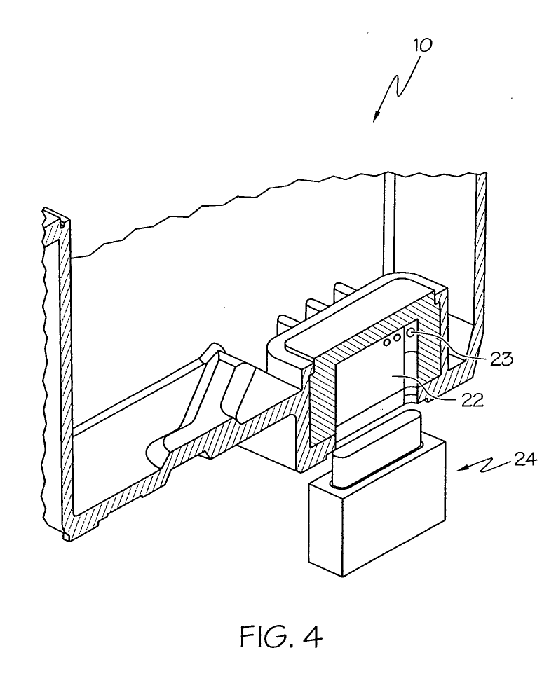

Other embodiments and configurations are also possible without departing from the principles of the inventions. For example, FIG. 4 is a cross sectional view of another example embodiment of a ink jet cartridge 10, which is made and operates in accordance with principles of the present inventions. In this example, many of the illustrative components are similar to those described above with respect to FIGS. 1-3, including removable tanks 13 and 15, chamber 14 and porous core 18. In one exemplary embodiment, the porous core comprises an air cavity 22 configured to capture air bubbles 23 within the ink flow. For example, the air cavity 22 can be made by using a mold core 24. The air cavity 22 allows ink to flow around the captured bubbles 23 and through the porous core 18 without the bubbles decreasing ink flow rate. In all other respects, the operation of these embodiments can be similar to that described above.

In another aspect of the present invention, a method of manufacturing the ink jet cartridge 10 is provided. To assemble, the porous core 12 is formed in the shape of a flow passage and placed, either manually or robotically, in an ink jet cartridge mold at the desired location. The mold is then closed and a molten material, such as plastic, is then injected around the porous core into the mold cavity. Upon cooling, the mold is opened and the ink jet cartridge 10 with the porous core 18 is removed.

The foregoing description of the various embodiments of the invention has been presented for the purposes of illustration and description. It is not intended to be exhaustive or to limit the invention to the precise form disclosed. Many alternatives, modifications and variations will be apparent to those skilled in the art of the above teaching. For example, some principles of the invention may be used in different ink jet cartridge configurations and types of printers. Moreover, although multiple inventive aspects have been presented, such aspects need not be utilized in combination, and various combinations of inventive aspects are possible in light of the various embodiments provided above. Accordingly, the above description is intended to embrace all possible alternatives, modifications, combinations, and variations that have been discussed or suggested herein, as well as all others that fall with the principles, spirit and broad scope of the inventions as defined by the claims.

What is claimed is:

1. A method of manufacturing an ink jet cartridge, comprising:
forming a porous core in the shape of a flow passage;
placing the porous core in an ink jet cartridge mold; and
injecting a molten material around the porous core.

2. The method as recited in claim 1, wherein the molten material forms an ink jet cartridge body.

3. The method as recited in claim 2, further comprising placing a printhead on the ink jet cartridge body, wherein the printhead comprises ink ejection nozzles and ink ejectors.

4. The method as recited in claim 3, wherein the ink ejection nozzles are in fluid communication with the porous core.

5. The method as recited in claim 1, wherein the porous core further comprises an air cavity.

6. The method as recited in claim 2, wherein the ink jet cartridge body comprises a chamber configured to contain ink, and further wherein the porous core is in fluid communication with the ink in the chamber.

7. The method as recited in claim 1, wherein the porous core is comprised of a material adapted to provide a porosity of at least about 63% to 65% of an open volume and a pore size of between 125 um and 250 um.

8. The method as recited in claim 1, wherein the porous core filters the ink from the ink tank.

9. The method as recited in claim 1, wherein the porous core is selected from the group consisting of polypropylene, nylon, polyethylene, fluoropolymers, porous copper and porous bronze or combinations thereof.

10. The method as recited in claim 2, wherein the ink jet cartridge body comprises a body floor, further wherein the body floor comprises the porous core.

11. An ink jet cartridge for an ink jet printer, comprising:
a porous core in the shape of a flow passage;
an ink jet cartridge body formed by injecting a molten material around the porous core, wherein the ink jet cartridge body comprises a chamber configured to contain ink, and further wherein the porous core is in fluid communication with the ink in the chamber; and
a printhead provided on the ink jet cartridge body and including ink ejection nozzles and ink ejectors, wherein the ink ejection nozzles are in fluid communication with the porous core.

12. The ink jet cartridge of claim 11, wherein the chamber and the printhead are in fluid communication with each other through the porous core.

13. The ink jet cartridge of claim 11, wherein the printhead comprises one or more heater chips.

14. The ink jet cartridge of claim 11, wherein the porous core further comprises an air cavity.

15. The ink jet cartridge of claim 11, wherein the porous core is comprised of a material with a porosity of at least about 63% to 65% an open volume and a pore size between 125 um and 250 um.

16. The ink jet cartridge of claim 11, wherein the porous core filters the ink from the ink tank.

17. The ink jet cartridge of claim 11, wherein the porous core is selected from the group consisting of polypropylene, nylon, porous copper and porous bronze or combinations thereof.

18. The ink jet cartridge of claim 11, wherein the ink jet cartridge body comprises a body floor, further wherein the body floor comprises the porous core.

19. A method of manufacturing an ink jet cartridge, comprising:
forming a porous core;
placing the porous core in an ink jet cartridge mold;
injecting a molten material around the porous core to form an ink jet cartridge body; and
providing a heater chip on the ink jet cartridge body that comprises ink ejection nozzles and ink ejectors, wherein the ink ejection nozzles are in fluid communication with the porous core.
